(19) United States
(12) Patent Application Publication
(10) Pub. No.: US 2007/0278999 A1
(43) Pub. Date: Dec. 6, 2007

(54) USB mini B power supply system for quickly charging USB mini B devices

(76) Inventor: Wen-Nan Hsia, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/536,695

(22) Filed: Sep. 29, 2006

(30) Foreign Application Priority Data
May 30, 2006 (TW) 095119193

(51) Int. Cl. H02J 7/02

(52) U.S. Cl. 320/111

(57) ABSTRACT

Power supply system for charging USB mini-B devices includes a charger and a USB mini-B device. The USB mini-B device includes a first pin receiving the DC current from the charger, a fourth pin receiving the DC current or identification data from the charger, a power management unit receiving DC current, a first switch transmitting the DC current from the first pin to the first input node of the power management when the first switch is on, a second switch transmitting the DC current from the first pin to the first input node of the power management when the second switch is on.

### BACKGROUND OF THE INVENTION

1. Field of the Invention

The present invention relates to a power system, and more particularly, to an USB mini B power supply system for quickly charging USB mini B devices.

2. Description of the Prior Art

Please refer to FIG. 1. FIG. 1 is a diagram illustrating a USB mini B plug and a USB mini B socket. As shown in FIG. 1, the USB mini B plug has pins 1 to 6, and the USB mini B socket has pins 1 to 6. When the USB mini B plug is coupled to the USB mini B socket, pins 1 to 6 of the plug are coupled to pin 1 to 6 of the socket respectively.

Please refer to FIG. 2. FIG. 2 is a diagram illustrating the pin definition of a standard USB mini B connector. The USB mini B standard defines pin 1 for transmitting power, pin 2 and pin 3 for transmitting data, pin 4 for identity, pin 5 for grounding, and pin 6 for shielding. Additionally, pin 6 of the USB mini B connector is the housing of the connector.

The USB mini B standard also defines the maximum current that a USB mini B socket device can sink. If the device coupled to the USB mini B socket device is a regular USB mini B plug device, then the maximum sink current is 500 milliamps. If the device coupled to the USB mini B socket device is a USB mini B power adaptor such as an ac/dc adaptor or a dc/dc adaptor, then the maximum sink current is 1 amp because the USB mini B connector only has one pin for transmitting power (pin 1) and one pin for grounding (pin 5) while each of them can be loaded with 1 amp at most under the hardware character of the USB mini B connector.

Therefore, in order to differentiate the type of a USB mini B plug device, the USB mini B socket device uses the voltage of pin 4 of the USB mini B socket. Pin 4 of the USB mini B plug of the USB mini B power adaptor is coupled to ground so that the voltage of pin 4 is low. Pin 4 of the USB mini B plug of the regular USB mini B device is floating so that the voltage of pin 4 is also floating. Pin 4 of the USB mini B socket of a USB mini B socket device such as a cell phone is coupled to a high-leveled voltage through a resistor.

Please refer to FIG. 3. FIG. 3 is a diagram illustrating the situation when the USB mini B socket device 330 is coupled to the regular USB mini B plug device 310 or the USB mini B power adaptor 320. When the USB mini B socket device 330 is coupled to the regular USB mini B plug device 310, the voltage of pin 4 of the regular USB mini B plug device 310 is pulled up to the high-leveled voltage by the USB mini B socket device 330 because pin 4 of the regular USB mini B plug device 310 is floating so that the voltage of pin 4 of the USB mini B socket of the USB mini B socket device 330 is high. When the USB mini B socket device 330 is coupled to the USB mini B power adaptor, the voltage of pin 4 of the USB mini B power adaptor 320 is still at the ground-leveled voltage so that the voltage of pin 4 of the USB mini B socket of the USB mini B socket device 330 is low. Thus, the USB mini B socket device can determine if the USB mini B device coupled to it is a regular USB mini B plug device or an USB mini B power adaptor. If the USB mini B socket device determines the USB mini B device is a regular USB mini B plug device, then sinking current is limited to 500 milliamps. If the USB mini B socket device determines the USB mini B device is a USB mini B power adaptor, then sinking current is not limited. Nevertheless, the sinking current is still at most 1 amp because of the hardware character of the connector.

However, from the description above, it is known that whatever the type of USB mini B plug device, the sinking current is only 1 amp at most, which is not enough for the USB mini B socket device to be charged with the sinking current very quickly. Thus, the user has to increase the charging time of the USB mini B socket device and that is an inconvenience.

### SUMMARY OF THE INVENTION

It is therefore an objective of the claimed invention to provide a power supply system for quickly charging USB mini B devices.

The claimed invention provides a power charger for quickly charging USB mini B devices and includes a power converter for converting an input power source into a direct current, and a USB mini B plug, of which a first pin and a fourth pin are coupled to an output node of the power converter for receiving direct current from the output node of the power converter.

The claimed invention also provides a USB mini B device for quickly being charged and includes a USB mini B socket having a first pin for receiving a direct current, and a fourth pin for receiving a direct current or a identity; a power management unit having a first input node for receiving a direct current; a first switch coupled between the first pin of the USB mini B socket and the first input node of the power management unit for transmitting the direct current of the first pin of the USB mini B socket to the first input node of the power management unit when the first switch is turned on; and a second switch coupled to the fourth pin of the USB mini B socket and the first input node of the power management unit for transmitting the direct current of the fourth pin of the USB mini B socket to the first input node of the power management unit when the first switch is turned on.

The claimed invention also provides a power supply system for quickly charging USB mini B devices and includes a charger having a power converter for converting an input power source into a direct current and a USB mini B plug having a first pin and a fourth pin coupled to an output node of the power converter for receiving a direct current from the output node of the power converter; a USB mini B device including a USB mini B socket having a first pin coupled to the first pin of the USB mini B plug for receiving the direct current from the first pin of the USB mini B plug and a fourth pin coupled to the fourth pin of the USB mini B plug for receiving the direct current or an identity from the fourth pin of the USB mini B plug; a power management unit having a first input node for receiving a direct current; a first switch coupled between the first pin of the USB mini B socket and the first input node of the power management unit for transmitting the direct current of the first pin of the USB mini B socket to the first input node of the power management unit when the first switch is turned on; and a second switch coupled between the fourth pin of the USB mini B socket and the first input node of the power management unit for transmitting the direct current of the fourth pin of the USB mini B socket to the first input node of the power management unit when the second switch is turned on.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a USB mini B plug and a USB mini B socket.

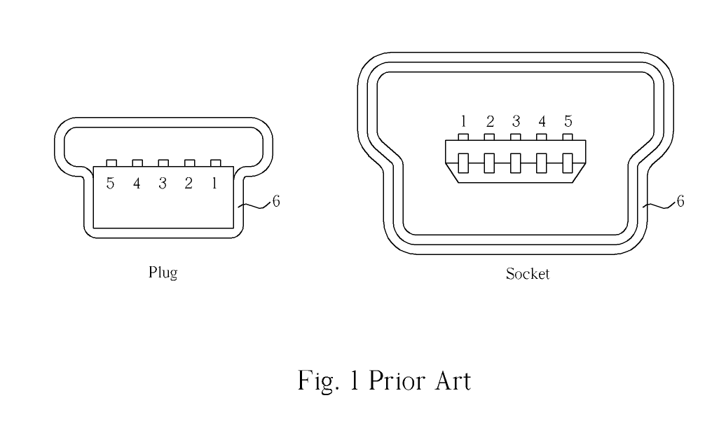

FIG. 2 is a diagram illustrating the pin definition of a standard USB mini B connector.

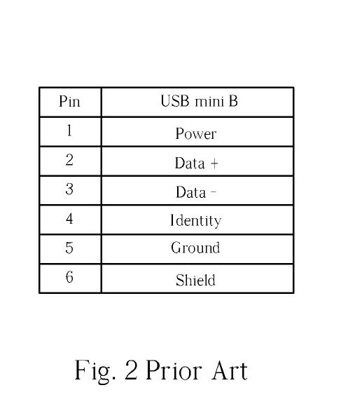

FIG. 3 is a diagram illustrating the situation when the USB mini B socket device is coupled to the regular USB mini B plug device or the USB mini B power adaptor.

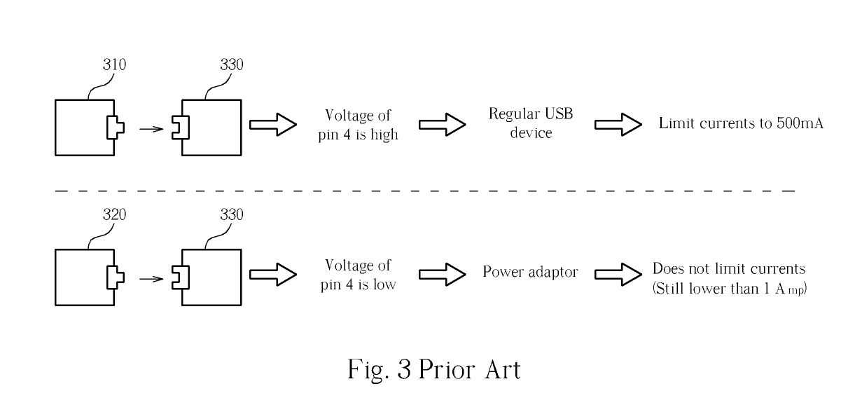

FIG. 4 is a diagram illustrating the definition of the USB mini B connector of the present invention.

FIG. 5 is a diagram illustrating a USB mini B power adaptor of the present invention.

FIG. 6 is a diagram illustrating the USB mini B socket device of the present invention.

FIG. 7 is a diagram illustrating the situation when the USB mini B socket device of the present invention is coupled to the power adaptor of the present invention.

FIG. 8 is a diagram illustrating the situation when the USB mini B socket device of the present invention is coupled to a regular USB mini B plug device or a regular USB mini B power adaptor.

### DETAILED DESCRIPTION

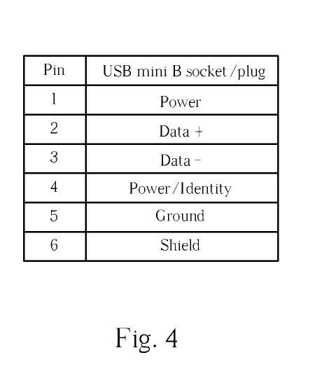

Please refer to FIG. 4. FIG. 4 is a diagram illustrating the definition of the USB mini B connector of the present invention. The difference between the USB mini B connector of the prior art and the present invention is that the USB mini B connector of the present invention uses pin 1 and pin 4 for transmitting power while the present invention is also compatible with the regular USB mini B devices. As shown in FIG. 4, the USB mini B power adaptor of the present invention uses pin 1 and pin 4 for providing the power, and pin 5 and pin 6 for grounding. Additionally, the USB mini B socket device of the present invention uses pin 1 for receiving the power, pin 4 for both identifying the type of the USB mini B device and receiving the power, and pin 5 and pin 6 for grounding. Thus, the USB mini B device of the present invention can transmit current up to 2 amps because the USB mini B connector of the present invention uses 2 pins for transmitting the power and 2 pins for grounding.

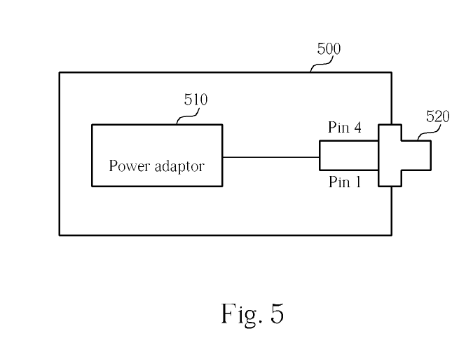

Please refer to FIG. 5. FIG. 5 is a diagram illustrating a USB mini B power adaptor 500 of the present invention. The USB mini B power adaptor 500 comprises an ac/dc adaptor 510. The ac/dc adaptor 510 comprises an output node and a ground node. The output node of the ac/dc adaptor outputs a direct current and is coupled to pin 1 and pin 4 of the USB mini B plug. The ground node of the ac/dc adaptor is coupled to pin 5 and pin 6 of the USB mini B plug. In this way, the ac/dc adaptor 510 uses the USB mini B plug defined by the present invention to provide the current up to 2 amps. Likewise, a dc/dc adaptor can be used for the USB mini B power adaptor 500 to provide direct current in the present invention.

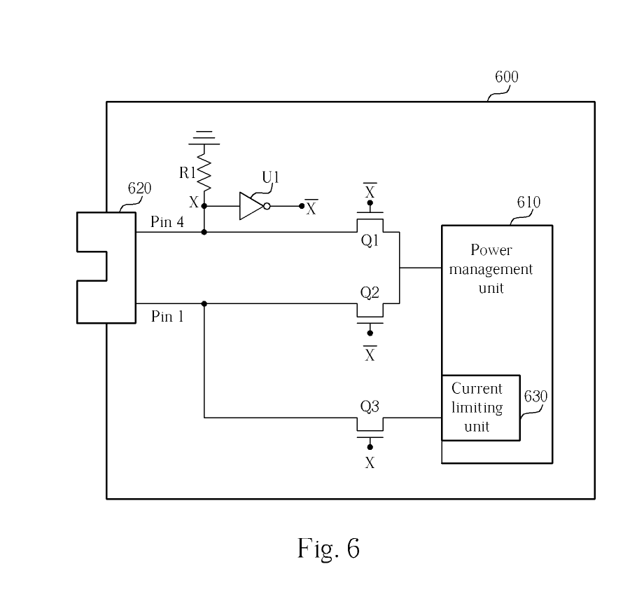

Please refer to FIG. 6. FIG. 6 is a diagram illustrating the USB mini B socket device 600 of the present invention. The USB mini B socket device 600 comprises a power management unit 610, a current-limiting unit 630, 3 transistors Q1, Q2, Q3, an inverter U1, and a resistor R1. The resistor R1 is coupled between ground and the USB mini B plug 620 for pulling the voltage of pin 4 of the USB mini B plug 620 down to ground. Thus the voltage of pin 4 of the USB mini B plug 620 holds ground-leveled voltage when not coupled to any external devices. The transistor Q1 is coupled between pin 4 of the USB mini B plug 620 and the power management unit 610. The signal X̅ at the gate of the transistor Q1 determines whether pin 4 of the USB mini B plug 620 is coupled to the input node of the power management unit 610. The transistor Q2 is coupled between pin 1 of the USB mini B plug 620 and the power management unit 610. The signal X̅ at the gate of the transistor Q2 determines whether pin 1 of the USB mini B plug 620 is coupled to the input node of the power management unit 610. The transistor Q3 is coupled between pin 1 of the USB mini B plug 620 and the power management unit 610. The signal X at the gate of the transistor Q3 determines whether pin 1 of the USB mini B plug 620 is coupled to the input node of the current-limiting unit 630 of the power management unit 610. The input node of the inverter U1 is coupled to pin 4 of the USB mini B plug 620. The signal on the input node of the inverter U1 is taken as signal X and also serves as the controlling signal of the transistor Q3 by coupling to the gate of the transistor Q3. Then the inverter U1 inverts the signal X of the input node to the signal X̅ output to the gates of the transistors Q1 and Q2.

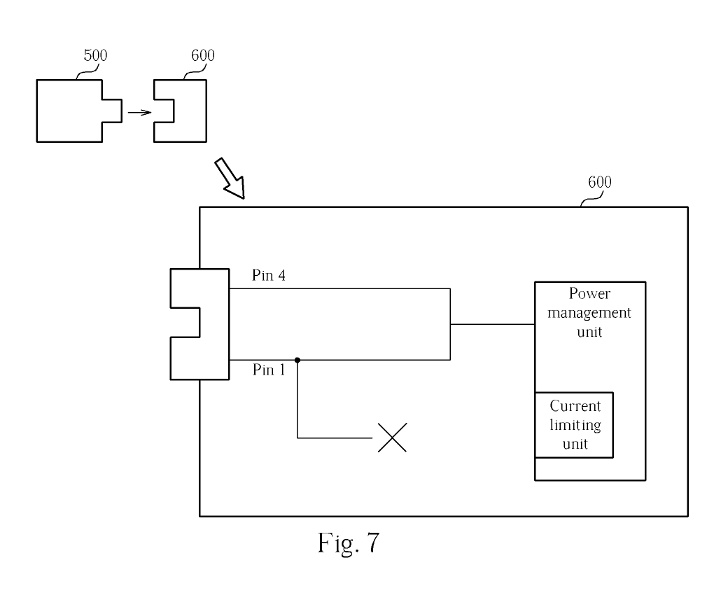

Please refer to FIG. 7. FIG. 7 is a diagram illustrating the situation when the USB mini B socket device 600 of the present invention is coupled to the power adaptor 500 of the present invention. As shown in FIG. 7, when the USB mini B power adaptor 500 is coupled to the USB mini B socket device 600, pin 4 of the USB mini B plug of the power adaptor 500 pulls the voltage of pin 4 of the USB mini B socket to a high-leveled voltage because pin 4 of the USB mini B plug is the direct current output of the USB mini B power adaptor 500. Thus, the signal X is high and the signal X̅ is low. Consequently, the transistors Q1 and Q2 are turned on and the transistor Q3 is turned off so that the direct current is transmitted from pin 1 and pin 4, through the transistors Q1 and Q2, to the input node of the power management unit 610. In this way, the power can be transmitted through 2 pins and thus the maximum current can be up to 2 amps.

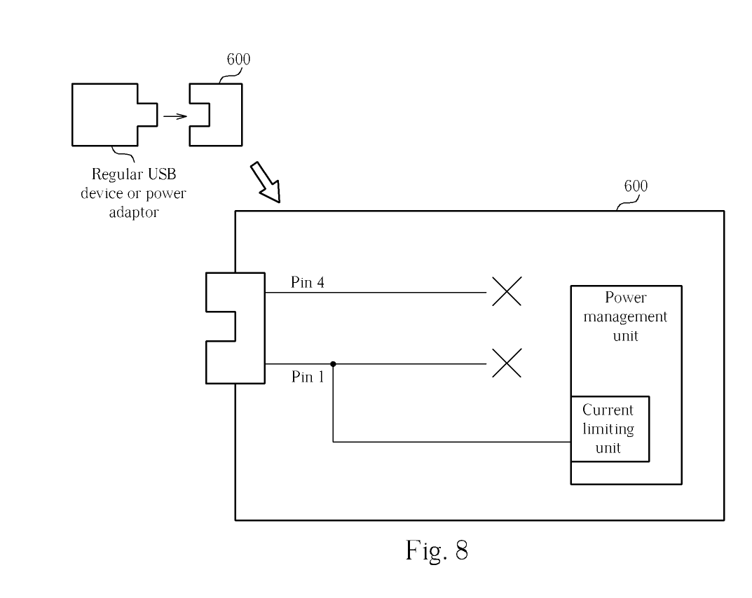

Please refer to FIG. 8. FIG. 8 is a diagram illustrating the situation when the USB mini B socket device 600 of the present invention is coupled to a regular USB mini B plug device or a regular USB mini B power adaptor. Pin 4 of the USB mini B plug of the regular USB mini B device is floating so that when the regular USB mini B plug device is coupled to the USB mini B socket device 600 of the present invention, the voltage of pin 4 of the plug is pulled down to the ground-leveled voltage through the resistor R1 and the voltage of pin 4 of the socket of the USB mini B socket device 600 is low. Pin 4 of the regular USB mini B power adaptor is coupled to ground so that when the regular USB mini B power adaptor is coupled to the USB mini B socket device 600, pin 4 of the USB mini B socket of the USB mini B socket device 600 is also low. Thus, whether the device coupled to the USB mini B socket device 600 is a regular USB mini B plug device or a regular USB mini B power adaptor, pin 4 of the USB mini B socket of the USB mini B socket device 600 is low. Consequently, the signal X is also low and the signal X̅ is high. According to the signals X and X, the transistors Q1 and Q2 are turned off and the transistor Q3 is turned on respectively. As shown in FIG. 8, through the transistor Q3, pin 1 of the USB mini B socket is coupled to the current-limiting unit 630 of the power management unit 610 so that the power output from the regular USB mini B plug device or the regular USB mini B power adaptor can be transmitted to the current-limiting unit 630.

Therefore, by using the power supply system of the present invention, the USB mini B devices can be charged quickly, save the charging time, and use the extra current for the need of the operation of the USB mini B devices, which increases the convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power charger for quickly charging USB (universal serial bus, USB) mini B devices, comprising:
a power converter converting an input power source into a direct current; and
a USB mini B plug of which a first pin and a fourth pin are coupled to an output node of the power converter receiving the direct current from the output node of the power converter.

2. The charger of claim 1, wherein the power converter is an ac/dc converter, converting an alternating current into a direct current.

3. The charger of claim 1, wherein the power converter is a dc/dc converter, converting a first input direct current into a second output direct current.

4. The charger of claim 1, wherein a fifth pin and a sixth pin of the USB mini B plug are coupled to ground.

5. An USB mini B device for quickly being charged, comprising:
a USB mini B socket comprising:
a first pin receiving a direct current; and
a fourth pin receiving a direct current or a identity;
a power management unit comprising a first input node receiving a direct current;
a first switch coupled between the first pin of the USB mini B socket and the first input node of the power management unit, transmitting the direct current of the first pin of the USB mini B socket to the first input node of the power management unit when the first switch is turned on; and
a second switch coupled to the fourth pin of the USB mini B socket and the first input node of the power management unit, transmitting the direct current of the fourth pin of the USB mini B socket to the first input node of the power management unit when the second switch is turned on.

6. The USB mini B device of claim 5, further comprising:
an inverter comprising:
an input node coupled to the fourth pin of the USB mini B socket; and
an output node coupled to a controlling node of the first switch and the second switch.

7. The USB mini B device of claim 5, further comprising:
a resistor coupled between the fourth pin of the USB mini B socket and ground.

8. The USB mini B device of claim 5, wherein the power management unit further comprises a second input node for receiving a direct current.

9. The USB mini B device of claim 8, wherein the power management unit further comprises:
a current-limiting unit coupled to the second input node of the USB mini B device, limiting the received direct current according to a USB current standard.

10. The USB mini B device of claim 9, further comprising:
a third switch, coupled between the first pin of the USB mini B socket and the second input node of the power management unit, transmitting the direct current of the first pin of the USB mini B socket to the second input node of the power management unit when the first switch is turned on.

11. The USB mini B device of claim 10, wherein a controlling node of the third switch is coupled to the fourth pin of the USB mini B socket.

12. A power supply system for quickly charging USB mini B devices, comprising:
a charger, comprising:
a power converter converting an input power source into a direct current; and
a USB mini B plug comprising a first pin and a fourth pin coupled to an output node of the power converter, receiving a direct current from the output node of the power converter;
a USB mini B device comprising:
a USB mini B socket comprising:
a first pin coupled to the first pin of the USB mini B plug, receiving the direct current from the first pin of the USB mini B plug; and
a fourth pin coupled to the fourth pin of the USB mini B plug, receiving the direct current or a identity from the fourth pin of the USB mini B plug;
a power management unit comprising a first input node, receiving a direct current;
a first switch coupled between the first pin of the USB mini B socket and the first input node of the power management unit, transmitting the direct current of the first pin of the USB mini B socket to the first input node of the power management unit when the second switch is turned on; and
a second switch coupled between the fourth pin of the USB mini B socket and the first input node of the power management unit, transmitting the direct current of the fourth pin of the USB mini B socket to the first input node of the power management unit when the first switch is turned on.

13. The power supply system of claim 12, wherein a fifth pin and a sixth pin of the USB mini B plug are coupled to ground.

14. The power supply system of claim 12, further comprising:
an inverter comprising:
an input node coupled to the fourth pin of the USB mini B socket; and
an output node coupled to a controlling node of the first switch and the second switch.

15. The power supply system of claim 12, further comprising a resistor coupled between the fourth pin of the USB mini B socket and ground.

16. The power supply system of claim 12, wherein the power management unit further comprises a second input node receiving a direct current.

17. The power supply system of claim 16, wherein the power management unit further comprises a current-limiting unit coupled to the second input node of the power management unit limiting the received direct current according to a USB current standard.

18. The power supply system of claim 17, further comprising:
a third switch coupled between the first pin of the USB mini B socket and the second input node of the power management unit, transmitting the direct current of the first pin of the USB mini B socket to the second input node of the power management unit when the third switch is turned on.

19. The power supply system of claim 18, wherein a controlling node of the third switch is coupled to the fourth pin of the USB mini B socket.

20. The power supply system of claim 12, wherein the power converter is an ac/dc converter, converting an alternating current into a direct current.

21. The power supply system of claim 12, wherein the power converter is a dc/dc converter, converting a first direct current into a second direct current.
